(19) United States
(12) Patent Application Publication
(10) Pub. No.: US 2010/0189024 A1
(43) Pub. Date: Jul. 29, 2010

(54) PS-Poll Transmission Opportunity in WLAN

(75) Inventors: Ariton E. Xhafa, Plano, TX (US); Shu Du, Richardson, TX (US); Arvind Swaminathan, San Diego, CA (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/692,783

(22) Filed: Jan. 25, 2010

Related U.S. Application Data
(60) Provisional application No. 61/146,937, filed on Jan. 23, 2009.

(51) Int. Cl. H04W 52/02

(52) U.S. Cl. 370/311

(57) ABSTRACT

Embodiments of the invention provide a dynamic priority adjustment algorithm for PS-Poll packets in WLAN and dynamic CW (contention window) management algorithm for PS-Poll packets in WLAN. These improve the performance of traffic flows associated with STAs in power save mode. Maintain the QoS requirements of the traffic flows. When PS-Poll packets are not able to be sent, the QoS STA will experience a long delay of the downlink data, even if the downlink data has been assigned a higher AC. The delay may potentially violate the QoS bound required by the data flow. Using the embodiments can significantly decrease the probability of this event.

### BACKGROUND

Embodiments of the invention are directed, in general, to communication systems and, more specifically, methods of improved PS-Poll transmission opportunity.

Current handset devices can support, in addition to voice communications, data communications. The latter one is due to the fact that these devices are equipped with different wireless data technologies, e.g., GPRS, EDGE, etc. The IEEE 802.11a/b/g/n WLAN technology IEEE 802.11-2007, Part 11: Wireless LAN Medium Access Control (MAC) and Physical Layer (PHY) specifications: Enhancements for Higher Throughput is also finding its way on these handsets. However, wireless local area network (WLAN) technology is a power hungry technology; hence battery power limitations remain a constraint and an important aspect/feature that requires improvement. Therefore, efficient power-saving mechanism is an important differentiating factor between different handset vendors.

Referring initially to FIG. 1, illustrated is a system diagram of a communications network in which embodiments of the invention operate, generally designated 100, employing a wireless local area network (WLAN). The communications network 100 includes a wired network 105 and a WLAN access point 110 having first and second WLAN end-user devices 112, 114. The WLAN access point 110 employs a wired coupling 106 to the wired network 105 and first and second wireless couplings 111a, 111b to the first and second WLAN end-user devices 112, 114, as shown. The WLAN access point 110 and WLAN end-user devices 112, 114 include a packet prioritizer 115 that provides priority tagging and transmission scheduling of WLAN packets which at the WLAN access point 110 is associated with the first and second WLAN end-user devices 112, 114.

The WLAN access point 110 provides a shared broadcast channel to the first and second WLAN end-user devices 112, 114 wherein airtime is a shared resource between the two. The first and second WLAN end-user devices 112, 114 may typically employ a range of applications having different quality of service requirements. These applications may include voice, video, music downloads, HTTP sessions, web browsing or e-mail to list a few possibilities. Voice applications may require transmissions that are close to real time, while e-mail could accommodate larger transmission delays without appreciably affecting quality of service.

The packet prioritizer 115 includes a priority tagger that provides a packet priority for each of the WLAN packets; and a priority scheduler, coupled to the priority tagger, that provides a strict priority scheduling of the WLAN packets through the WLAN access point 110 based on the packet priority. The strict priority scheduling consistently schedules a higher priority WLAN packet ahead of a lower priority WLAN packet through the WLAN access point 110.

In the illustrated embodiment, the packet prioritizer 115 also includes a priority parameter adapter that adapts at least one operation-specific parameter for the packet priority based on a channel loading condition of the WLAN access point or the WLAN devices 110. The operation-specific parameters include an inactive packet priority category, an arbitration interframe spacing, a minimum contention window and a maximum contention window.

IEEE 802.11 standard specifies its power-saving mechanism used by WLAN stations. This mechanism works as follows:
The WLAN node informs the access point (AP) that it goes in PowerSave (PS) mode and the AP begins buffering packets that are addressed for this node.
AP periodically sends beacons which include traffic indication map (TIM) informing the nodes that are in PS mode whether there are buffered packets for these nodes or not.
If a node learns from the TIM that the AP has buffered packets for it, the node transmits a PowerSave Polling (PS-Poll) frame after a period of time. The duration of the time depends on the number of active-mode stations (STAs) present in the network, as well as the number of PS-mode STAs informed via TIM.
Once the AP receives the PS-Poll, it responds to it with an acknowledgment (ACK) and thereafter sends a buffered data packet to the STA. The AP can also send a buffered data packet directly to the STA immediately after receiving PS-Poll (without sending ACK first). In either case, the “more data bit indicator” of the sent data packet header could be set to “1” if there are more buffered packets for this node, or “0” if there are no more packets left in the buffer for this node. The node/STA will schedule another PS-Poll if more data bit is set to “1” and the process continues.

The above PS-Poll approach can indeed save STAs significant power as they can turn off their transmitters and receivers from time to time without losing their data service. However, the PS-Poll approach also suffers from the following pitfalls in a scenario where traffic destined to it has stringent Quality-of-Service (QoS) requirements:
In a QoS supported WLAN network, such as an IEEE 802.11e WLAN IEEE 802.11e, Draft 13.0—Wireless LAN Media Access Control (MAC) and Physical Layer (PHY) Specifications: Ammendment—Medium Access Control (MAC) Quality of Service Enhancements, IEEE, 2005., the PS-Poll is delivered as “best effort” packet. Therefore, the PSPoll packet is queued in the access category of best effort (AC_BE) before transmissions and follows backoff transmission procedures of AC_BE. If the network has other higher traffic categories to transmit, transmission of PS-Poll may be delayed for a long time.
As a consequence, delaying of PS-Poll transmission at the node/STA that is in PS mode may result in buffer overflow at the AP.
In addition, if the PS-Poll packet gets lost src_short_retry_limit times, the node/STA in PS mode has to wait till it receives the next beacon and learns that there are more data bit queued for this node, before it can send/transmit a new PS-Poll.
Furthermore, if the AP is buffering data of high access category for the STA, it may have to wait longer than delay requirements for the buffered data may allow. Thus, the buffered data may violate quality of service (QoS) requirements

There is a need for a new solution to address and prevent the above mentioned problems.

### BRIEF DESCRIPTION OF THE DRAWINGS

Having thus described the invention in general terms, reference will now be made to the accompanying drawings, which are not necessarily drawn to scale, and wherein:

FIG. 1 is a system diagram illustrative of an embodiment of a communications network employing a wireless local area network (WLAN) in which embodiments of the invention operate;

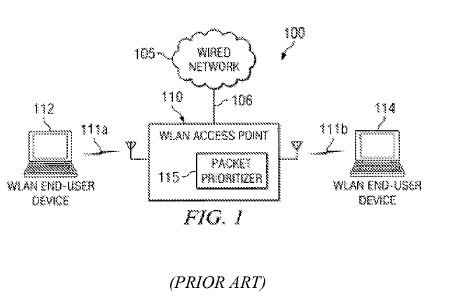

FIG. 2 is a flow chart illustrative of the dynamic priority adjustment algorithm in accordance with embodiments of the invention; and

FIG. 3 is a flow chart illustrative of the dynamic contention window (CW) management algorithm in accordance with embodiments of the invention.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

To address the issues that we mentioned above, embodiments of the invention provide two orthogonal solutions. In another word, the following two algorithms can be used simultaneously or independently.

### Dynamic Priority Adjustment Method for PS-Poll Packets in WLAN

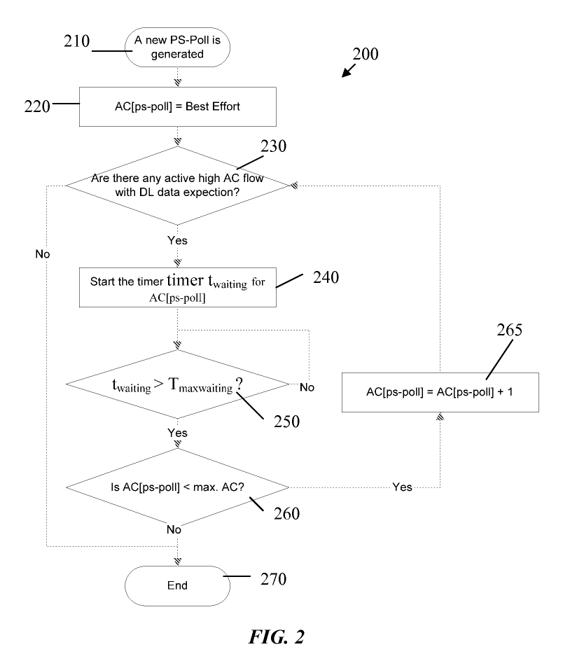

FIG. 2 is a flow chart illustrative of the dynamic priority adjustment method. Dynamic priority adjustment method 200 begins with a new PS-Poll being generated 210. The access category AC of a PS-Poll is initially assigned as access category best effort AC_BE 220.

A determination of any active high AC flows with down link expectation is made 230. If a STA in PS-mode does not have any active flows, or all the active flows of the STA only have priority as BE (best effort category), or all the active flows that have higher priority than BE do not have downlink data, the PS-Poll packets of the STA will remain in the AC_BE category and method end 270. If a STA in PS-mode does have at least one active flow that has an access category (AC) higher than the BE and the flow expects downlink data from AP, the dynamic priority adjustment for PS-Polls is triggered.

A time threshold T_{MaxWaiting} is used to guard the maximum waiting time after a PS-Poll packet is inserted into the AC queue. A timer t_{waiting} is also trigger to start 240 once the PS-Poll is inserted into the current assigned AC queue. Typically, a PS-Poll is generated 210 and is inserted into the queue when the last received beacon or the last received data indicates that the STA has buffered data packets in AP.

If t_{waiting}>T_{MaxWaiting}, 250 then the PS-Poll packet is moved to the next higher access category 265 and the process returns to 230. At the same time, the timer t_{waiting} is restarted 240. A different value of T_{MaxWaiting} may also be assigned based on the current AC. If PS-Poll is transmitted before t_{waiting}<T_{MaxWaiting}, then cancel t_{waiting} timer. The steps in this paragraph will be repeated until the PS-Poll has moved to the maximum AC 260. If the PS-Poll is already in the maximum AC, the PS-Poll will remain in this category until it is finally delivered or dropped due to too many retries.

As mentioned, the value of T_{MaxWaiting} may have different values for different AC. The higher the AC is, the smaller shall be the value of T_{MaxWaiting}. The recommended T_{MaxWaiting} values for each AC can be found empirically or via simulations.

The use of T_{MaxWaiting} shall be independent of the retransmission limit applied to the PS-Poll packets. Overall, the PS-Poll will still be bounded by a limited number of retransmissions no matter which AC the PS-Poll is inserted to.

### Dynamic Contention Window CW Management Method for PS-Poll Packets in WLAN

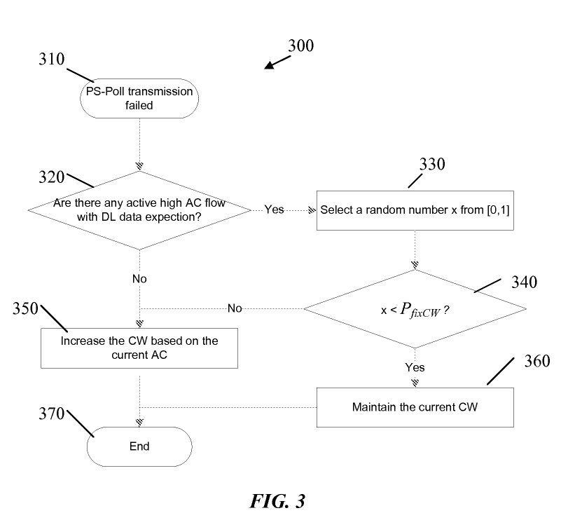

FIG. 3 is a flow chart illustrative of the dynamic CW management method. The dynamic CW management method begins with a PS-Poll transmission failure 310.

First, if a STA in PS-mode does not have any active flows, or all the active flows of the STA belong to AC_BE traffic category, or all the active flows that belong to higher access categories than AC_BE do not have downlink data, the contention window size increases as dictated by the assigned AC of the PS-Poll.

Second, if a STA in PS-mode has at least one active flow that belongs to an AC that is higher than the AC_BE and the flow expects downlink data from AP, the dynamic CW for PS-Polls is triggered 320. A random number x is set from [0,1] 330. A determination is made if x is less than probability P_{fixCW} 340. If x is less than probability P_{fixCW}, then the current CW is maintained 360 and process ends 370. If x is not less than probability P_{fixCW}, then the CW is increased based on current AC 350.

If a PS-Poll is lost (the STA does not receive the PSPoll-ACK for the transmitted PS-Poll), instead of always increasing the contention window (CW) size as specified in the standard, embodiments of the invention provide that with probability P_{fixCW}, the STA keeps the contention window for PS-Poll at the same value for retransmissions. In this approach, with the probability (1-P_{fixCW}), the STA increases the contention window (CW) size based on the assigned PS-Poll access category and the standard specification.

For a short packet like PS-Poll, if the PS-Poll was not received correctly due to channel errors, then no other packet or communication will be able to be received correctly between the AP and the node/STA in PS mode. Therefore, in this scenario the communication between the AP and the STA is not possible, unless the PS-Poll packet was using a higher data rate than the minimum data rate. The more likely scenario is that the PS-Poll was lost due to collisions in the wireless medium. Therefore, all other STAs that collided will increase their CW, while the node/STA in PS mode that uses dynamic CW management algorithm will maintain its CW size. Therefore, the chances of the PS-Poll being successfully retransmitted increases.

The probability P_{fixCW} is used to avoid the scenario when all STAs in PS mode follow the same practice (i.e., keep CW constant). This decision could be based on a random probability distribution, e.g., uniform distribution. It is unlikely that the STAs colliding are both in PS mode, unless the number of STAs in PS-mode is considerably high.

The recommended P_{fixCW} values for each AC can be found empirically or via simulations.

Because the proposed solutions are MAC based solutions, there is no additional support required at the PHY layer. At the MAC layer, however, the following changes should be implemented to support the above solutions:
1. A single timer t_{waiting} may be needed to calculate the time elapsed since the last PS-Poll was enqueued.
2. T_{MaxWaiting} and P_{fixCW} may need register storage. In case their values are different based on the current AC of the PS-Poll packets. Multiple values should be stored correspondingly for each AC.

PS-Poll packets potentially may impact the QoS traffic performance when the packets are sent as Best Effort Access Category packet. In the embodiments of the invention, two algorithms are used to improve the medium access priority of the PS-Poll. The dynamic priority adjustment algorithm may increase the AC of the PS-Poll if the PS-Poll packet cannot be delivered within a predefined amount of time; while the dynamic CW management algorithm will maintain the CW size of the PS-Poll retransmission based on predefined probability threshold. The two algorithms can be combined or used independently to improve the PS-Poll medium access delay.

PSPoll frames may always be queued in best effort access category, regardless of the traffic flow that they are sent for. Embodiments of the invention use dynamic thresholds to increase the priority of PSPoll frames when the network is congested.

Embodiments of the invention improve the performance of traffic flows associated with STAs in power save mode and maintain the QoS requirements of the traffic flows. When PS-Poll packets are not able to be sent, the QoS STA will experience a long delay of the downlink data, even if the downlink data has been assigned a higher AC. The delay may potentially violate the QoS bound required by the data flow. The use of the proposed algorithms can significantly decrease the probability of this event.

Embodiments of the invention also lower the buffer requirements at the AP. When PS-Poll packets are delayed at the STAs for a long time duration, the AP will have to buffer the data destined for STAs for a long time. When the buffer is full, the AP may have to start dropping data packets, which will impact STA's application services. Using the embodiments of the invention, lower buffer size is needed at the AP while maintaining QoS for the traffic flows at the STAs in the PS mode.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A method for packet transmission in a communications network, said method comprising:
generating a PowerSave Polling (PS-Poll) frame having an access category (AC);
assigning best effort (BE) to said access category (AC-BE);
determining if a station (STA) has any active flows with down link expectation and an high AC;
If a STA in PS-mode does have at least one active flow that has an access category (AC) higher than the BE and the flow expects downlink data from AP, dynamically adjusting priority comprising:
setting a time threshold T_{MaxWaiting} for guarding a maximum waiting time after a PS-Poll packet is inserted into an AC queue;
triggering a timer t_{waiting};
when t_{waiting} is greater than T_{MaxWaiting}, then said AC is moved to the next higher AC;
restarting said timer t_{waiting};
assigning a different time threshold T_{MaxWaiting} value; and
repeating the above steps from “triggering a timer t_{waiting}” till “assigning a different time threshold T_{MaxWaiting} value” until said AC of said PS-Poll has moved to the maximum AC.

2. The method of claim 1, further comprising:
cancelling timer if PS-Poll packet is transmitted before t_{waiting} is greater than T_{MaxWaiting},

3. The method of claim 1, wherein said time threadhold T_{MaxWaiting} may have different values for different access catagories and wherein the higher the AC is, the smaller shall be the value of said time threadhold T_{MaxWaiting}.

4. The method of claim 1, further comprising upon PS-Poll transmission failure:
setting a random number x is set from [0,1];
determining if x is less than a predetermined probability P_{fixCW}
maintaining a current contention window if x is less than probability P_{fixCW},
increasing said contention window based on the current AC, if x is not less than probability P_{fixCW}.
